(19) United States
(12) Patent Application Publication
(10) Pub. No.: US 2025/0339871 A1
(43) Pub. Date: Nov. 6, 2025

(54) MOBILE PAINTING SYSTEM FOR PAINTING COMPONENTS

(71) Applicant: US Auto Supply, Elgin, IL (US)

(72) Inventor: Brian James O'Reilly, Pingree Grove, IL (US)

(21) Appl. No.: 18/655,966

(22) Filed: May 6, 2024

(51) Int. Cl. B05C 13/02

(52) U.S. Cl. CPC B05B 13/0285; B05C 13/02; F16M 11/42

(57) ABSTRACT

A mobile painting system for painting components comprising a base unit, a vertical mast, at least one movable bracket disposed on the vertical mast, and a mobile unit disposed on the base unit.

### FIELD

The preferred embodiment relates to mobile painting systems for facilitating painting of multiple components from desired angles and orientations.

### BACKGROUND

In many facilities engaged in activities such as auto body repair, auto restoration, construction, and house renovation, painting services become essential. In such facilities, it is often necessary to paint all or multiple components.

In a typical painting facility, a separate enclosed painting booth is usually provided to be used by paint technicians to paint different components. The painting booth helps to control the painting environment and provide necessary lighting and ventilation for the painting application. The painting booth also provides ample space for the paint technicians to move the multiple components in multiple directions/orientations and carry out the right painting job required for each of the multiple components that need to be painted.

A major factor in achieving skillful painting results is the ability to arrange and orient the multiple components in a desired manner needed by each of the individual components while painting. To achieve this, paint stands are commonly employed by paint technicians. Paint stands for mounting components to be painted would ideally be mobile and properly align each component, enabling access to all the dimensions of the components for ease of painting. However, the presently available stands do not allow for mounting of multiple components for painting while also providing easy alignment/orientation for each of the components and mobility to easily move the paint stand across different types of floor surfaces (i.e., floor of the painting booth).

An example of currently available painting stands for painting multiple components is disclosed in U.S. Pat. No. 6,158,701, which discloses a painting stand for painting a fender. While the prior devices such as those described in the '701 patent provide some improvement in the art and in some instances have had certain commercial success, they are limited in their functionality and are subject to numerous faults. There are stands which permit for the mounting of multiple panels at the same time, but they do not provide for mobility and alignment/orientation for each component, independent of other components, during the painting job.

There remains an unresolved and unfulfilled need in the art for a more efficient mobile painting system for painting multiple components, which allows mounting of multiple components simultaneously, enables the appropriate alignment/orientation of the each of the components, independent of other components, and confers mobility such that the painting system could easily be moved across different types of floor surfaces.

### SUMMARY

Disclosed herein are approaches for addressing various of the problems and shortcomings of the state of the art, as identified above. More particularly, disclosed herein are mobile systems for mounting and painting multiple components.

According to a first aspect of the present disclosure, there is provided a mobile painting system for painting components comprising a base unit, a vertical mast, at least one movable bracket disposed on the vertical mast, and a mobile unit disposed on the lower side of the base plate. The base unit comprises a base plate having an upper side and a lower side, a receiver disposed on the upper side of the base plate, and at least one support rod, where each support rod has a first end and a second end. The first end of the support rod is mechanically connected to the receiver and the second end of the support rod is mechanically connected to the upper side of the base plate. The vertical mast includes an upper end and a lower end, where the lower end of the vertical mast is mechanically connected to the upper side of the base plate via the receiver. The at least one movable bracket is configured to hold at least one holding arm for holding the components to be painted. The at least one movable bracket is also configured to translate along a vertical axis of the vertical mast and rotate about the vertical axis of the vertical mast. The mobile unit is configured for moving the mobile painting system between locations.

According to a second aspect of the present disclosure, there is provided a mobile painting system for painting components comprising a base unit, a vertical mast, eight movable brackets disposed on the vertical mast, and a mobile unit disposed on the lower side of the base plate. The base unit comprises a base plate having an upper side and a lower side, a receiver disposed on the upper side of the base plate, and four support rods, where each support rod has a first end and a second end. The first end of the each of the four support rods is mechanically connected to the receiver and the second end of each of the four support rods is mechanically connected to the upper side of the base plate. The vertical mast includes an upper end and a lower end, where the lower end of the vertical mast is mechanically connected to the upper side of the base plate via the receiver. Each of the eight movable brackets is configured to hold at least one holding arm for holding the components to be painted. Each of the eight movable brackets is also configured to translate along a vertical axis of the vertical mast and rotate about the vertical axis of the vertical mast independent of each of the other movable brackets. The mobile unit is configured for moving the mobile painting system between locations. The mobile unit includes four support legs, each having a proximal end and a distal end. The proximal end of each of the four support legs is mechanically connected to the lower side of the base plate. The mobile unit also includes a lockable caster mechanically connected to the distal end of each of the four support legs.

### BRIEF DESCRIPTION OF THE DRAWINGS

FIG. 1 shows a perspective view of an exemplary aspect of a mobile painting system.

FIG. 2A shows a perspective view of an exemplary embodiment of a base unit according to an aspect of the mobile painting system.

FIG. 2B shows a top view of an exemplary embodiment of the base unit according to an aspect of the mobile painting system.

FIG. 2C shows a side view of an exemplary embodiment of the base unit according to an aspect of the mobile painting system.

FIG. 2D shows a perspective view of an exemplary embodiment of a base plate according to an aspect of the mobile painting system.

FIG. 2E shows a perspective view of an exemplary embodiment of a receiver according to an aspect of the mobile painting system.

FIG. 2F shows a perspective view of an exemplary embodiment of a support rod according to an aspect of the mobile painting system.

FIG. 3A shows a perspective view of an exemplary embodiment of a vertical mast according to an aspect of the mobile painting system.

FIG. 3B shows an exploded view of an exemplary embodiment of the vertical mast according to an aspect of the mobile painting system.

FIG. 4A shows a perspective view of an exemplary embodiment of a movable bracket according to an aspect of the mobile painting system.

FIG. 4B shows a front view of an exemplary embodiment of the movable bracket according to an aspect of the mobile painting system.

FIG. 4C shows a side view of an exemplary embodiment of the movable bracket according to an aspect of the mobile painting system.

FIG. 4D shows a rear view of an exemplary embodiment of the movable bracket according to an aspect of the mobile painting system.

FIG. 4E shows a top view of an exemplary embodiment of the movable bracket according to an aspect of the mobile painting system.

FIG. 4F shows an exploded view of an exemplary embodiment of the movable bracket according to an aspect of the mobile painting system.

FIGS. 5A-5A2 show perspective views of an exemplary embodiment of a holding arm according to an aspect of the mobile painting system.

FIGS. 5B-5B2 show perspective views of an exemplary embodiment of the holding arm according to an aspect of the mobile painting system.

FIGS. 5C-5C2 show perspective views of an exemplary embodiment of the holding arm according to an aspect of the mobile painting system.

FIG. 6A shows a perspective view of an exemplary embodiment of a mobile unit according to an embodiment of the mobile painting system.

FIG. 6B shows a perspective view of an exemplary embodiment of a support leg according to an aspect of the mobile painting system.

FIG. 6C shows a perspective view of an exemplary embodiment of a lockable caster according to an aspect of the mobile painting system.

FIG. 7 shows a perspective view of an exemplary aspect of a mobile painting system.

### DETAILED DESCRIPTION

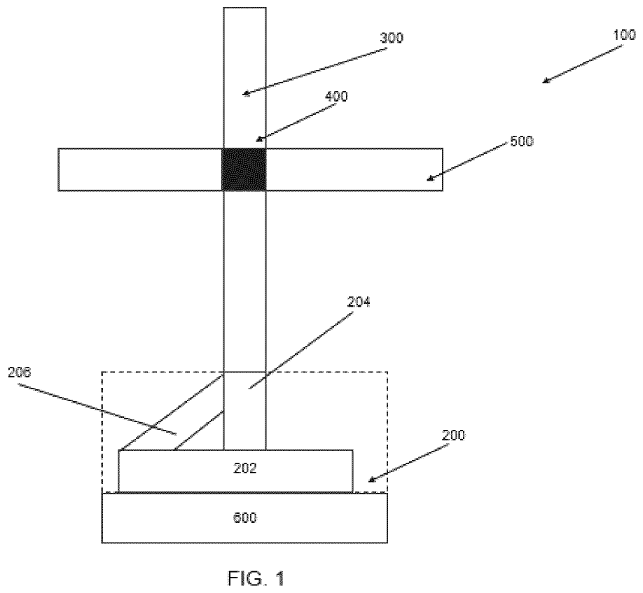

Referring to the drawings, FIG. 1 shows a perspective view of an exemplary aspect of a mobile painting system 100. FIG. 1 also presents the primary structural components of the mobile painting system 100. These include a base unit 200, a vertical mast 300 articulating with the base unit 200, a movable bracket 400 disposed on the vertical mast 300, a holding arm 500 movably coupled to the movable bracket 400, and a mobile unit 600 coupled to the base unit 200. The holding arm 500 is configured to hold the components to be painted. The components that could be mounted onto the holding arm 500 can include construction material, automotive parts, and panel surfaces. The mobile unit 600 is configured to confer mobility to the mobile painting system 100 which could allow the paint technician to move the mobile painting system 100 across different floor surfaces.

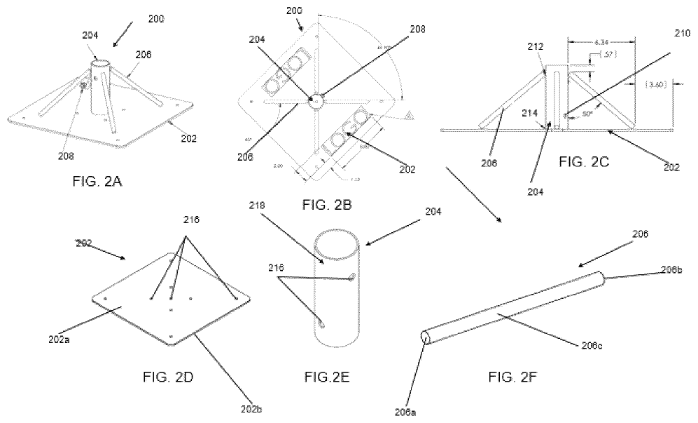

Referring to FIGS. 2A-2C, a perspective view, a top view, and a side view of an exemplary embodiment of the base unit 200 according to an aspect of the mobile painting system 100, are shown respectively. The base unit 200 (as shown in FIG. 1) includes a base plate 202, a receiver 204 disposed on the base plate 202, and at least one support rod 206 mechanically connected to the receiver 204 and the base plate 202. The support rods 206 are configured to receive and distribute the load from the vertical mast 300 and the receiver 204, and could stabilize the mobile painting system 100, especially when the mobile painting system 100 is moved.

The embodiment of the base unit 200 presented in FIGS. 2A-2C includes a base plate 202, a receiver 204, and four support rods 206 mechanically connected to the receiver 204 and the base plate 202. In this embodiment, the four support rods 206 are arranged in an orientation where a distance between two adjacent support rods 206 are the same. In some embodiments of the base unit 200, the base unit 200 could have between one support rod 206 and four support rods 206. In other embodiments of the base unit 200, the base unit 200 could have more than four support rods 206. In further embodiments of the base unit 200, the support rods 206 can be arranged in an orientation where the distance between any two adjacent support rods 206 could be varied and not equal.

Referring to FIG. 2B, in the embodiment of the base unit 200 shown, the receiver 204 includes a hollow tube 218 configured to receive a portion of the vertical mast 300. In this embodiment of the base unit 200, the portion of the vertical mast 300 could be coupled of the base unit 200 through the receiver 204. In this embodiment of the base unit 200, the receiver 204 further includes a compression screw 208 configured to interface with the portion of the vertical mast 300 to secure the portion of the vertical mast 300 with the receiver 204. In some embodiments of the base unit, the receiver 204 could include a solid cylinder tube 218 instead of the hollow tube 218, which could be coupled to the vertical mast 300. In the embodiments where the receiver 204 includes the solid cylinder tube 218, the vertical mast 300 could be coupled to the receiver 204 via welding.

Referring to FIG. 2C, in the embodiment of the base unit 200 shown, the support rods 206 each have a first end 206a and a second end 206b, where the first end 206a of the support rod 206 could be coupled to the receiver 204 and where the second end 206b of the support rod 206 could be coupled to the base plate 202. In the embodiment of the base unit 200 shown in FIG. 2C, the support rod 206 is mechanically coupled to the receiver 204 and the base plate 202 via welding. In the same embodiment, the first end 206a of the support rod 206 is mechanically to the receiver 204 via a weld bead 212. In this embodiment of the base unit 200, the receiver 204 is mechanically connected to the base plate 202 via a weld joint 214. In the same embodiment of FIG. 2C, the support rods 206 are mechanically connected to the receiver 204 and the base plate 202 such that an angle between each of the support rods 206 and the receiver 204 is 50°. In some embodiments of the base unit 200, the angle between each of the support rods 206 and the receiver 204 could be greater than 50°. In other embodiments of the base unit 200, the angle between each of the support rods 206 and the receiver 204 could be lesser than 50°.

Referring to FIG. 2D-2F, perspectives views of an exemplary embodiment of the base plate 202, receiver 204, and the support rod 206 are presented, respectively. The embodiment of the base plate 202 presented in FIG. 2D includes an upper side 202a and a lower side 202b. The lower side 202b could be configured to be coupled with the mobile unit 600 (presented in FIG. 1) of the mobile painting system 100. The upper side 202a could be configured to interface with components of the base unit 200 such as the support rods 206 and the receiver 204. The embodiment of the base plate 202 presented in FIG. 2D further includes a plurality of connector screw threads 216 on the upper side 202a. The connector screw threads 216 can articulate with connector screws 220 which allow for interfacing between components of the mobile painting system 100 like the vertical mast 300 with the base plate 202. In some embodiments of the base unit 200, the base plate 202 could be made from a high-density metal alloy such as heavy-duty steel.

Referring to FIG. 2E, an embodiment of the receiver 204 is presented. The embodiment of the receiver 204 presented in FIG. 2E includes the hollow tube 218 for receiving the portion of the vertical mast 300 and a plurality of compression screw threads 210 configured to articulate with compression screws 208. In some embodiments of the receiver 204, as discussed above, the receiver 204 can include a solid cylinder tube 218 instead of a hollow tube 218 as presented in FIG. 2E. In some embodiments of the receiver 204, the receiver 204 is made from a high-density metal alloy such as heavy-duty steel.

Referring to FIG. 2F, an embodiment of the support rod 206 is presented. The embodiment of the support rod 206 presented in FIG. 2E includes a cylindrical column 206c, the first end 206a and the second end 206b for mechanically connecting with the receiver 204 and base plate 202, respectively. In some embodiments of the support rod 206, the cylindrical column 206c of the support rod 206 could be hollow. In some embodiments of the support rod 206, the support rod 206 is made from a metal alloy such as heavy-duty steel or copper.

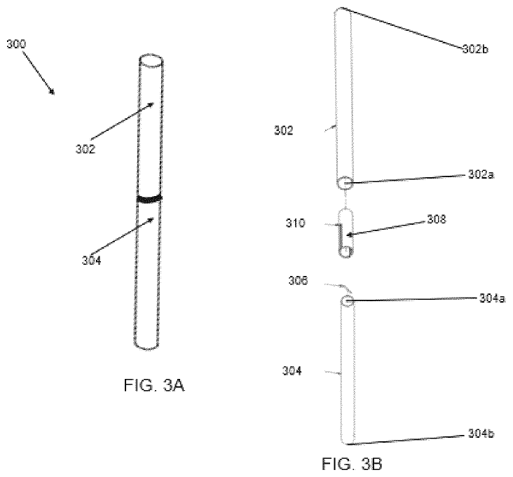

FIGS. 3A-3B present a perspective view and an exploded view of an exemplary embodiment of the vertical mast 300 of the mobile painting system 100. In the embodiment of the vertical mast 300 presented in FIGS. 3A-3B, the primary components of the vertical mast 300 include an upper core 302, a lower core 304, a connector 308, and a restrictor 306. In this embodiment of the vertical mast 300, the upper core 302 includes a closed end 302b and an open end 302a, where the connector 308 is configured fit into the open end 302a of the upper core 302. In this embodiment of the vertical mast 300, the lower core 304 also includes a closed end 304b and an open end 304a, where a restrictor 306 is disposed on the open end 304a of the lower core 304. In some embodiments of the vertical mast 300, the closed end 304b of the lower core 304 further includes a connector screw 220 that can articulate with the connector screw threads 216 on the base plate 202 to secure the vertical mast 300 to the base plate 202.

In this embodiment of the vertical mast 300 presented in FIGS. 3A-3B, the connector 308 is configured fit into the open end of the lower core 304. In the same embodiment of vertical mast 300, the restrictor further includes a restrictor slot 310 configured to receive the restrictor 306 disposed on the open end 304a of the lower core 304, thereby allowing the upper core 302 and the lower core 304 to interface and form the vertical mast 300. In some embodiments of the vertical mast 300, the upper core 302 and the lower core 304 can be interfaced together via welding. In other embodiments of the vertical mast 300, the upper core 302 could have external connector threads that align with internal connector threads of the lower core 304, such that upper core 302 and the lower core 304 could be connected via alignment of the external connector threads and the internal connector threads. In some embodiments of the vertical mast 300, the vertical mast 300 is made from a metal alloy such as stainless steel or high-grade aluminum.

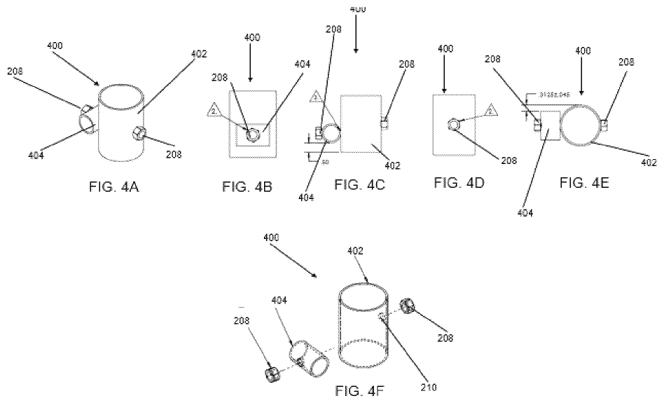

Referring to FIGS. 4A-4F, a perspective view, a front view, a rear view, a side view, a top view, and an exploded view of an exemplary embodiment of the movable bracket 400 according to an aspect of the mobile painting system 100, are shown respectively. The movable bracket 400 includes a bracket column 402 and an arm length adjuster 404 disposed on the bracket column 402. In the embodiment show in FIGS. 4A-4F, the bracket column 402 further includes a compression screw thread 210 for articulation with a compression screw 208 for securing the movable bracket 400 to the vertical mast 300. In this embodiment of the movable bracket 400, the movable bracket 400 could be movable along a vertical axis of the vertical mast 300 or rotatable about the vertical axis of the vertical mast 300 by means of engagement of the compression screw 208 to secure the movable bracket 400 at a location on the vertical mast 300 and disengagement of the compression screw 208 to allow the movable bracket 400 to be translated or rotated along a vertical axis of the vertical mast 300. In the embodiment of the movable bracket 400 presented in FIGS. 4A-4F, a diameter of the bracket column 402 is greater than a diameter of the vertical mast 300, allowing for the movable bracket 400 to fit around the vertical mast 300. In some embodiments of the movable bracket 400, the bracket column 402 could include two pieces, which can be taken apart and clasped together around the vertical mast 300.

Referring to the embodiments of the movable bracket 400 presented in FIGS. 4A-4F, the arm length adjuster 404 is disposed on the bracket column 402 on the movable bracket 400. In this embodiment of the arm length adjuster 404, the holding arm 500 (shown in FIG. 1) is configured to movably couple with the arm length adjuster 404 such that the holding arm 500 can be moved along a horizontal axis of the arm length adjuster 404. In some embodiments of the movable bracket 400, the arm length adjuster 404 could be welded onto the bracket column 402. In other embodiments of the movable bracket 400, the arm length adjuster further can be coupled onto the bracket column 402 via a screw. In the embodiment of the arm length adjuster 404 presented in FIGS. 4A-4F, the arm length adjuster 404 further includes a compression screw thread 210 for articulation with a compression screw 208 to interface with the holding arm 500 to secure the holding arm 500 in the arm length adjuster 404. In some embodiments of the movable bracket 400, the movable bracket 400 is made from a metal alloy such as stainless steel or high-grade aluminum.

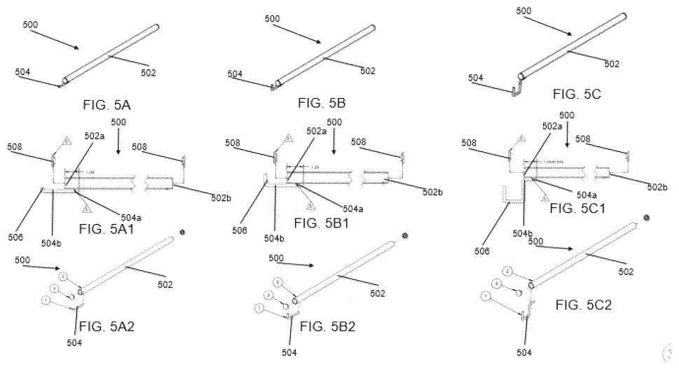

FIGS. 5A-5A2 show perspective views of an exemplary embodiment of a holding arm 500 according to an aspect of the mobile painting system 100. In the embodiment of the holding arm 500 presented in FIGS. 5A-5A2, the holding arm 500 includes an arm column 502, a first end 502a and a second end 502b, where each end includes a cap 508. The embodiment of the holding arm 500 presented in FIGS. 5A-5A2 further includes a hook extension 504 with a proximal end 504a, coupled to the first end 502a of the holding arm 500, and a distal end 504b including a shallow L-shaped protrusion 506 for holding the components to the painted. In some embodiments of the holding arm 500, the proximal end of the hook extension 504 with the shallow L-shaped protrusion is welded onto the first end 502a of the holding arm 500.

FIGS. 5B-5B2 show perspective views of an exemplary embodiment of a holding arm 500 according to an aspect of the mobile painting system 100. In the embodiment of the holding arm 500 presented in FIGS. 5B-5B2, the holding arm 500 includes an arm column 502, a first end 502a and a second end 502b, where each end includes a cap 508. The embodiment of the holding arm 500 presented in FIGS. 5B-5B2 further includes a hook extension 504 with a proximal end 504a, coupled to the first end 502a of the holding arm 500, and a distal end 504b including a deep L-shaped protrusion 506 for holding the components to the painted. In some embodiments of the holding arm 500, the proximal end of the hook extension 504 with the deep L-shaped protrusion 506 is welded onto the first end 502a of the holding arm 500.

FIGS. 5C-5C2 show perspective views of an exemplary embodiment of a holding arm 500 according to an aspect of the mobile painting system 100. In the embodiment of the holding arm 500 presented in FIGS. 5C-5C2, the holding arm 500 includes an arm column 502, a first end 502a and a second end 502b, where each end includes a cap 508. The embodiment of the holding arm 500 presented in FIGS. 5C-5C2 further includes a hook extension 504 with a proximal end 504a, coupled to the first end 502a of the holding arm 500, and a distal end 504b including a U-shaped protrusion 506 for holding the components to the painted. In some embodiments of the holding arm 500, the proximal end of the hook extension 504 with the U-shaped protrusion 506 is welded onto the first end 502a of the holding arm 500.

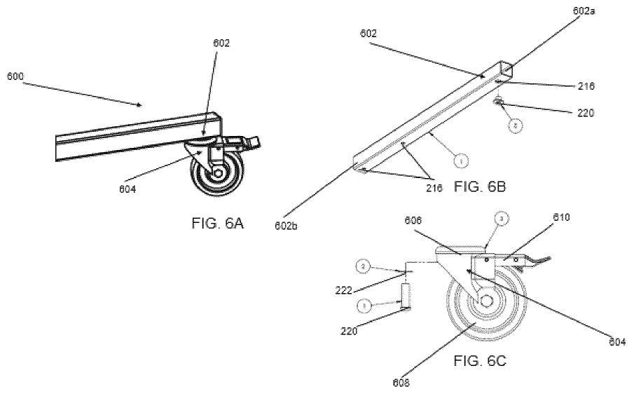

Referring to FIG. 6A, a perspective view of an exemplary embodiment of the mobile unit 600 according to an embodiment of the mobile painting system 100 is shown. In the embodiment presented in FIG. 6A, the mobile unit 600 includes one support leg 602 with a proximal end 602b and a distal end 602a, and a lockable caster 604 disposed on the distal end 602a of the support leg 602. In some embodiments of the mobile unit 600, the support leg 602 includes more than one lockable caster 604. In further embodiments of the mobile unit 600, the proximal end 602b of the support leg 602 is coupled to the lower side 202b of the base plate 202 via welding. In other embodiments, such as the embodiment of the support leg 602 shown in FIG. 6B, the proximal end 602b of the support leg 602 further includes a connector screw thread 216 configured to articulate with a connector screw 220 which could be used to couple the support leg 602 to the lower side 202b of the base plate 202.

Referring to FIG. 6C, a perspective view of an exemplary embodiment of the lockable caster 604 according to an aspect of the mobile painting system 100 is shown. In the embodiment shown in FIG. 6C, the lockable caster 604 includes a swivel bracket 606, a rotatable wheel 608 coupled to the swivel bracket 606, and wheel brake 610 disposed on the swivel bracket 606. In this embodiment shown in FIG. 6C, the swivel bracket 606 could be coupled to the distal end 602a of the support leg 602 via a connector screw 220 and a connector screw thread 216. In some embodiments of the lockable caster 604, the swivel bracket 606 could be configured to rotate about a vertical axis of the connector screw 220.

In the embodiment of the lockable caster 604 presented in FIG. 6C, the wheel brake 610 disposed on the swivel bracket 606 could be used to restrict motion of the rotatable wheel 608. In this embodiment, when the wheel brake 610 is an engaged position, the wheel brake 610 directly interfaces with the rotatable wheel 608 and restricts the motion of the rotatable wheel 608. In this embodiment, when the wheel brake 610 is a disengaged position, the wheel brake 610 does not interface with the rotatable wheel 608 and therefore not impeding motion of the rotatable wheel 608. In some embodiments of the lockable caster 604, the wheel brake 610 is a foot brake configured to be switch between the engaged and disengaged positions with a foot pedal.

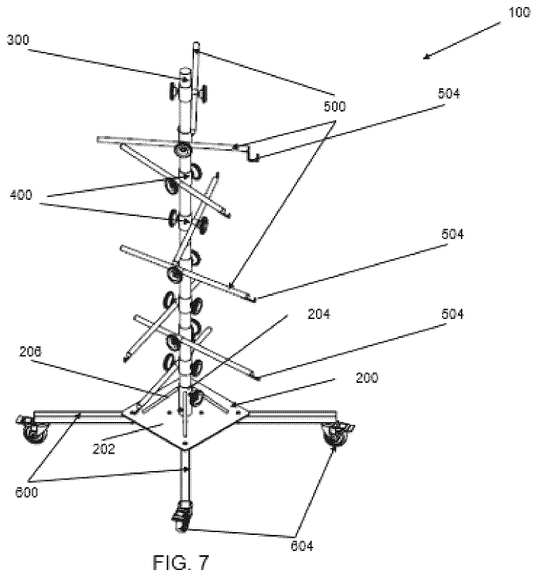

Referring to the drawings, FIG. 7 shows a perspective view of an exemplary aspect of a mobile painting system 100. FIG. 7 also presents the primary structural components of the mobile painting system 100. These include a base unit 200, a vertical mast 300 articulating with the base unit 200, eight movable brackets 400 disposed on the vertical mast 300, a holding arm 500 movably coupled to each of the movable brackets 400, and a mobile unit 600 coupled to the base unit 200, the mobile unit.

In the aspect of the mobile painting system presented in FIG. 7, each of the holding arms 500 is configured to hold the components to be painted. The components that could be mounted onto the holding arm 500 can include construction material, automotive parts, and panel surfaces. The mobile unit 600 is configured to confer mobility to the mobile painting system 100 which could allow the paint technician to move the mobile painting system 100 across different floor surfaces.

Referring to FIG. 7, each of the holding arms 500 include an arm column 502, a first end 502a and a second end 502b, where each end includes a cap 508. In the aspect of the mobile painting stand 100 presented in FIG. 7, each of the holding arms 500 further include a hook extension 504 with a proximal end 504a, coupled to the first end 502a of the holding arm 500, and a distal end 504b including a protrusion 506 for holding the components to the painted. The protrusion 506 are selected from group including shallow L-shaped protrusions, deep L-shaped protrusions, and U-shaped protrusions.

Referring to FIG. 7, the base unit 200 includes a base plate 202, a receiver 204 disposed on the base plate 202, and four support rod 206 mechanically connected to the receiver 204 and the base plate 202. The four support rods 206 are configured to receive and distribute the load from the vertical mast 300 and the receiver 204, and could stabilize the mobile painting system 100, especially when the mobile painting system 100 is moved. As presented in FIG. 7, the four support rods 206 are arranged in an orientation where a distance between two adjacent support rods 206 are the same.

Referring to FIG. 7, the mobile unit 600 includes four support legs 602, each with a proximal end 602b and a distal end 602a, and a lockable caster 604 disposed on the distal end 602a of each of the support legs 602. As shown in FIG. 7, the lockable caster 604 includes a swivel bracket 606, a rotatable wheel 608 coupled to the swivel bracket 606, and wheel brake 610 disposed on the swivel bracket 606. In this aspect of the mobile painting system 100, the swivel bracket 606 is coupled to the distal end 602a of each of the support legs 602 via a connector screw 220 and a connector screw thread 216 such that the swivel bracket 606 could be configured to rotate about a vertical axis of the connector screw 220. In some embodiments, the connector screw 220 is articulated to the connector screw thread 216 along with a washer 218 for a tighter connection.

Referring to FIG. 7, the rotatable wheel disposed 608 on the swivel bracket 606 could be used to restrict motion of the rotatable wheel 608. In this embodiment, when the wheel brake 610 is an engaged position, the wheel brake 610 directly interfaces with the rotatable wheel 608 and restricts the motion of the rotatable wheel 608. In this embodiment, when the wheel brake 610 is a disengaged position, the wheel brake 610 does not interface with the rotatable wheel 608 and therefore not impeding motion of the rotatable wheel 608.

While the advantages and preferred embodiments of the present invention have been described hereinbefore, those skilled in the art should be understood that the above are merely several illustrative embodiments of the present invention without limiting the scope thereof, wherein various modifications, alterations or substitutions may be made to the specific components of the embodiments without departing from the spirit and scope of the invention and its claims.

1. A mobile painting system for painting components, the mobile painting system comprising:
a base unit comprising:
a base plate having an upper side and a lower side;
a receiver disposed on the upper side of the base plate; and
at least one support rod, each having a first end and a second end, wherein the first end is mechanically connected to the receiver and the second end is mechanically connected to the upper side of the base plate;
a vertical mast having an upper end and a lower end, wherein the lower end of the vertical mast is mechanically connected to the upper side of the base plate via the receiver;
at least one movable bracket disposed on the vertical mast, wherein the at least one movable bracket is configured to translate along a vertical axis of the vertical mast and rotate about the vertical axis of the vertical mast;
at least one holding arm movably coupled to the at least one movable bracket; and
a mobile unit disposed on the lower side of the base plate, the mobile unit configured for moving the mobile painting system between locations.

2. The mobile painting system of claim 1, wherein the at least one support rod is mechanically connected to the receiver and the upper side of the base plate via welding.

3. The mobile painting system of claim 2, wherein the at least one support rod further comprises four support rods.

4. The mobile painting system of claim 3, wherein any two adjacent support rods of the four support rods are equidistant from each other.

5. The mobile painting system of claim 4, wherein the receiver is a hollow column configured to house a portion of the vertical mast.

6. The mobile painting system of claim 5, wherein the vertical mast comprises:
a hollow upper core including a closed end and an open end;
a hollow lower core including a closed end and an open end, the hollow lower core comprising the portion of the vertical mast housed by the receiver; and
a connector configured to connect the hollow upper core and the hollow lower core, the connector including a first end, a second end and a slot disposed along a vertical axis of the connector.

7. The mobile painting system of claim 6, further including a restrictor disposed on the open end of the lower core, wherein:
the first end of the connector is configured to fit into the open end of the hollow upper core;
the second end of the connector is configured to fit into the open end of the hollow lower core; and
the slot is configured to receive the restrictor when the second end of the connector is fit into the open end of the hollow lower core.

8. The mobile painting system of claim 7, wherein the closed end of the hollow lower core includes a screw configured to articulate with at least one screw thread disposed on the upper side of the base plate.

9. The mobile painting system of claim 1, wherein the at least one movable bracket further includes:
a bracket column configured to fit around the vertical mast, the bracket column configured to have a diameter greater than a diameter of the vertical mast;
an arm length adjuster disposed on the bracket column, wherein the at least one holding arm is movably coupled to the arm length adjuster, the at least one holding arm including a first end, a second end and an arm column; and
at least one compression screw thread disposed on the bracket column, the at least one compression screw thread configured to articulate with a compression screw.

10. The mobile painting system of claim 9, wherein the at least one holding arm is configured to be movable along a horizontal axis of the arm length adjuster.

11. The mobile painting system of claim 10, wherein the arm length adjuster further includes the at least one compression screw thread, the at least one compression screw thread configured to articulate with the compression screw to stabilize the at least one holding arm with the arm length adjuster.

12. The mobile painting system of claim 11, at least one holding arm further including a hook extension with a proximal end and a distant end, wherein:
the proximal end of the hook extension is mechanically connected to the first end of the at least one holding arm; and
the distal end of the hook extension is configured for holding the components to be painted.

13. The mobile painting system of claim 12, wherein the distal end of the hook extension includes a shallow L-shaped protrusion configured for holding the components to be painted.

14. The mobile painting system of claim 12, wherein the distal end of the hook extension includes a deep L-shaped protrusion configured for holding the components to be painted.

15. The mobile painting system of claim 12, wherein the distal end of the hook extension includes a U-shaped protrusion configured for holding the components to be painted.

16. The mobile painting system of claim 1, wherein the mobile unit comprises:
at least one support leg having a proximal end and distal end, the proximal end, mechanically connected to the lower side of the base plate; and
at least one lockable caster mechanically connected on the distal end of the at least one support leg.

17. The mobile painting system of claim 16, wherein the at least one lockable caster further includes:
a swivel bracket;
a rotatable wheel attached to the swivel bracket; and
a wheel brake disposed on the swivel bracket,
wherein the wheel brake is configured to move between an engaged and disengaged position, and
wherein the wheel brake is configured to restrict movement of the rotatable wheel in the engaged position.

18. The mobile painting system of claim 17, wherein the swivel bracket is attached to the distal end of the at least one support leg via a connector screw articulated through a connector screw thread disposed on the distal end of the at least one support leg and wherein the swivel bracket is configured to be rotatable about a vertical axis of the connector screw.

19. A mobile painting system for painting panels, the mobile painting system comprising:
a base unit comprising:
a base plate having an upper side and a lower side;
a receiver disposed on the upper side of the base plate; and
four support rods, each having a first end and a second end, wherein the first end is mechanically connected to the receiver and the second end is mechanically connected to the upper side of the base plate;
a vertical mast having an upper end and a lower end, wherein the lower end of the vertical mast is mechanically connected to the upper side of the base plate via the receiver;
eight movable brackets disposed on the vertical mast, wherein each of the eight movable brackets is configured to translate along a vertical axis of the vertical mast and rotate about the vertical axis of the vertical mast independent of each of other movable brackets;
at least one holding arm movably coupled to each of the eight movable brackets; and
a mobile unit disposed on the lower side of the base plate, the mobile unit configured for moving the mobile painting system between locations, the mobile unit comprising:
four support legs, each having a proximal end and distal end, the proximal end of each of the four support legs mechanically connected to the lower side of the base plate; and
a lockable caster mechanically connected to the distal end of each of the four support legs.

20. The mobile painting system of claim 19, wherein the at least one holding arm includes a hook extension with a proximal end and a distant end, wherein:
the proximal end of the hook extension is mechanically connected to the first end of the at least one holding arm; and
the distal end of the hook extension includes a protrusion configured for holding the components to be painted, wherein the protrusion is selected from a group including: a shallow L-shaped protrusion, a deep L-shaped protrusion, and a U-shaped protrusion.
